(19) United States
(12) Patent Application Publication
(10) Pub. No.: US 2026/0329600 A1
(43) Pub. Date: Oct. 22, 2026

(54) RENDER-TIME EXECUTION OF FUNCTIONALITY FOR VISUAL ASSETS IN COMPUTING SYSTEMS

(71) Applicant: FIGMA, INC., San Francisco, CA (US)

(72) Inventors: Alexander Simon KERN, San Mateo, CA (US); Benjamin DERBING, Brooklyn, NY (US); Nikolas KLEIN, San Francisco, CA (US)

(21) Appl. No.: 19/183,625

(22) Filed: Apr. 18, 2025

(51) Int. Cl. G06F 9/451

(52) U.S. Cl. CPC G06F 9/451

(57) ABSTRACT

Embodiments of the present disclosure provide techniques for executing functionality attached to a visual asset when the visual asset is rendered in an execution environment. An example method includes detecting a triggering event with respect to a visual asset. Generally, the visual asset may be configured to execute functionality defined by an external code asset. One or more visual components of the visual asset to be modified are identified based on the functionality defined by the external code asset and the triggering event. The functionality is executed based on rendering the one or more visual components of the visual asset in an executable environment in which the visual asset is rendered.

### BACKGROUND

### Field of the Various Embodiments

Embodiments of the present disclosure relate generally to rendering visual assets in a computing system and, more specifically, to techniques for render-time execution of functionality for visual assets in a computing system.

### Description of the Related Art

Graphic design tools generally allow for the creation of visual assets in a design environment. These visual assets may be defined, for example, as vector assets defined in terms of mathematical relationships between different components or raster assets defined in terms of absolute pixel locations. In some cases, a visual asset may include one or more containers, defined in the vector space, in which raster assets (e.g., images) can be inserted. A visual asset may include any number of visual components, and a visual asset may be defined in terms of relative positioning or other spatial relationships between visual components in the visual asset.

Visual assets designed in a graphic design tool may be associated with functionality that executes when actions are performed with respect to the visual asset or a related visual asset in an execution environment in which the visual asset is deployed. For example, a visual asset may include or be associated with an event handler that listens for specified events (e.g., losing or gaining focus, hovering events, clicks, text input, etc.), and different events may be associated with different actions performed with respect to that visual asset or a related visual asset in the execution environment. During execution within the execution environment, however, state information associated with a visual asset may be unavailable until the visual asset is rendered. Because state information associated with a visual asset may not be available until the visual asset is rendered, context-dependent actions associated with a visual asset or related visual assets rendered in the execution environment may not be able to be performed.

As the foregoing illustrates, what is needed are more effective techniques for executing functionality associated with visual content rendered in an execution environment.

### SUMMARY

One embodiment of the present disclosure provides techniques for render-time execution of functionality associated with a visual asset rendered in an execution environment. An example method includes detecting a triggering event with respect to a visual asset. Generally, the visual asset may be configured to execute functionality defined by an external code asset. One or more visual components of the visual asset to be modified are identified based on the functionality defined by the external code asset and the triggering event. The functionality is executed based on rendering the one or more visual components of the visual asset in an executable environment in which the visual asset is rendered.

One technical advantage of the disclosed techniques relative to the prior art is that the disclosed techniques allow for functionality for a visual asset to be executed in a design environment based on contextual information associated with the visual asset(s) rendered in the execution environment when the visual asset is rendered. Typically, when visual assets are rendered in an execution environment, contextual information about the visual asset (e.g., state information, content included in the visual asset, etc.) may not be available until the asset is rendered (or the rendering is updated). By executing functionality associated with a visual asset when the visual asset is rendered in the execution environment, embodiments presented herein may allow for the functionality associated with the visual asset to be performed based on properties or other contextual information associated with the visual asset. That is, because contextual information associated with a visual asset may be unavailable until the visual asset is rendered, executing functionality when the visual asset is rendered may allow for complex actions based on the current state of the visual asset (e.g., content included in a visual asset or other contextual information) that cannot be performed when the state of the visual asset is unknown (e.g., prior to the visual asset being rendered in the execution environment).

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present disclosure.

FIG. 2 illustrates execution of functionality associated with a visual asset in an execution environment when the visual asset is rendered based on traversing a rendering graph, according to some embodiments.

FIG. 3 is a flow diagram of method steps for executing functionality associated with a visual asset when the visual asset is rendered, according to some embodiments.

FIG. 4 illustrates a network computing system to implement an interactive graphic application platform, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

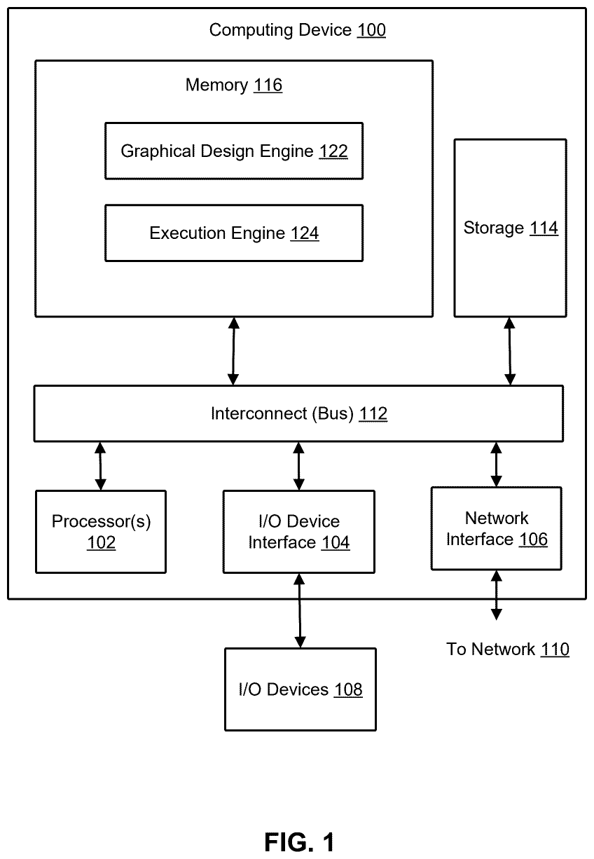

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a graphical design engine 122 and an execution engine 124 that reside in a memory 116.

It is noted that the computing device described herein is illustrative and that any other technically feasible configurations fall within the scope of the present disclosure. For example, multiple instances of graphical design engine 122 or execution engine 124 could execute on a set of nodes in a distributed and/or cloud computing system to implement the functionality of computing device 100. In another example, graphical design engine 122 or execution engine 124 could execute on various sets of hardware, types of devices, or environments to adapt graphical design engine 122 or execution engine 124 to different use cases or applications. In a third example, graphical design engine 122 or execution engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Graphical design engine 122 and execution engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including graphical design engine 122 or execution engine 124.

### Example Render-Time Execution of Functionality for Visual Assets in an Execution Environment

In graphical design software, such as that implemented by the graphical design engine 122 illustrated in FIG. 1, visual assets, such as user interface components in a user interface deployed to and rendered via code execution by execution engine 124, may be rendered and designed prior to deployment to the execution engine 124. A visual asset, as used herein, may be a group of visual components rendered in a user interface. Visual assets may be defined a priori (e.g., as code templates or pre-designed code-defined visual components in the graphical design engine 122) or may be designed by a user of the graphical design engine 122 and implemented in code. The visual asset may be, for example, a canvas in which other visual assets are rendered and in which user interaction can be processed, interactive visual assets rendered on a canvas, or the like.

Generally, the functionality of a visual asset may be defined in terms of triggers (also referred to as triggering events), actions, and states of the visual asset. For example, a specific action may be performed when a trigger occurs, and the specific action may depend on the current state of the visual asset. Some actions may be performed once or may not be repeatable when the visual asset is in a given state. In an illustrative example, rendering undisplayed content (i.e., making content appear on screen) may only occur if the content is not visible when a triggering event (e.g., interaction with a button, scrolling to a defined location in a webpage or other document, etc.) occurs; if the content is already visible, the content may not appear again. In another example, different actions may occur for the same trigger depending on the state of the visual asset; for example, in a scrolling action defined for the visual asset, scrolling behavior such as the speed at which content appears or a style in which content appears (e.g., a transformation applied to previously-displayed content that results in the display of new content) may differ based on the location in the content that is being displayed or other state information associated with the visual asset in which the content is being displayed.

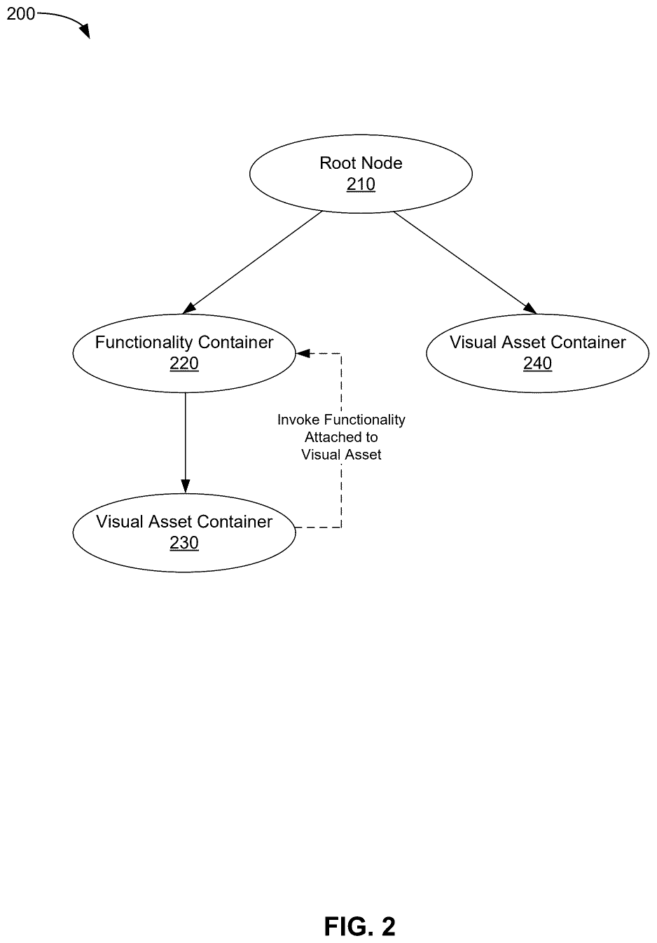

During execution of an application including visual assets designed in the graphical design engine 122, execution engine 124 can generate a rendering tree 200, illustrated in FIG. 2, to represent the visual assets being rendered and the functionality associated with the rendered visual assets. For example, in a web application or other application in which the elements of the application can be represented by a tree, a root node 210 in the rendering tree 200 generally corresponds to the overall document or canvas being loaded into an execution environment provided by execution engine 124. In a webpage or other document defined in hypertext markup language (HTML), the root node may correspond to the “<html>” tag in the document.

When execution engine 124 loads a document including renderable visual assets and associated functionality into the execution environment, execution engine 124 traverses the document to identify visual assets to be added to the rendering tree 200. The nodes added to the rendering tree 200 may include (i) containers in which other visual assets or functional assets (e.g., code) associated with a visual asset are contained, (iii) the visual assets themselves, and/or (iv) other assets that define properties of the document but may not be rendered by execution engine 124 during traversal of the rendering tree 200. For example, the rendering tree 200 may include one or more nodes associated with header information for the document loaded into the execution engine 124 or other nodes that include information that is not rendered in the execution environment. For visual assets that are defined as a collection of visual components, a node may be generated as a container for the collection of visual components, and execution engine 124 can generate additional nodes associated with the visual components in the visual asset. The nodes associated with the visual components in the visual asset may be loaded into the rendering tree 200 as children nodes of the node generated for the container associated with the visual asset.

As an illustrative example, suppose that a document loaded into execution engine 124 for rendering and execution includes a first visual asset associated with a functional code component and a second visual asset not associated with a functional code component. The document may include the functional code component in a first container that encapsulates the first visual asset in another container, and the document may include the second visual asset in a separate container. To generate the rendering tree 200 for this document, execution engine 124 traverses the document to identify the components included on the document and generates three nodes: a functionality container 220, a first visual asset container 230, and a second visual asset container 240. Because the first visual asset is contained within the container holding the functional component associated with the visual asset, execution engine 124 inserts the functionality container 220 node into the rendering tree 200 as a child node of the root node 210 and inserts the first visual asset container 230 node into the rendering tree 200 as a child ode of the functionality container 220 node. Meanwhile, execution engine 124 can insert the visual asset container 240 node associated with the second visual asset into the rendering tree 200 as a child node of the root node 210.

After the rendering tree 200 is generated, execution engine 124 can render the document and execute functionality associated with visual assets on the document based on traversing the rendering tree 200. Regardless of whether execution engine 124 traverses the rendering tree 200 based on breadth-first or depth-first traversal, typical traversal techniques may not allow for execution of code that performs various actions based on the contents or other contextual information associated with a visual asset, as the contents or other contextual information associated with the visual asset may be unknowable until the visual asset is rendered. Thus, to allow for functionality to be executed with respect to a visual asset rendered in an execution environment based on the content or other contextual information associated with the visual asset, execution engine 124 is configured to execute functionality when a visual asset is rendered (e.g., during traversal of the rendering tree 200) or otherwise when a rendering event to which the functionality is hooked (e.g., via a rendering hook) occurs. As used herein, a rendering hook may link the rendering of visual assets in an execution environment to functional code that defines how the content contained in a visual asset or the visual asset itself is to be rendered when defined events occur.

A visual asset in a document loaded into an execution environment generally may be defined by a unique asset name and include various properties that are unknowable to execution engine 124 and functional code in the document until the visual asset is rendered. To execute functionality associated with a visual asset when execution engine 124 renders the visual asset, the code defining the functionality (and represented by the functionality container 220 node in rendering tree 200) may hook into the rendering of the visual asset. That is, when execution engine 124 triggers a rendering event for a visual asset (e.g., reaches a node corresponding to a visual asset in the rendering tree 200), execution engine 124 can invoke the functional code associated with the visual asset (e.g., code associated with the functionality container 220 node in rendering tree 200). To hook into the rendering of a visual asset, execution engine 124 can define one or more interfaces associated with specific components of a document loaded in execution engine 124 and rendering paradigms for content rendered in execution engine 124. For example, a rendering hook may be defined for rendering characters in a visual asset (e.g., an HTML element in a webpage). Different rendering hooks may be associated with per-character rendering, per-line rendering, and per-string/substring rendering. One or more functions used to render text included in a visual asset in the document may specify one of the rendering hooks to be used in rendering content in a visual asset.

When execution engine 124 traverses the rendering tree 200 and reaches the visual asset container 230 for which a functionality container 220 defines functionality, execution engine 124 reaches into the visual asset in visual asset container 230 to obtain the content of and contextual information associated with the visual asset. In reaching into the visual asset, execution engine 124 retrieves one or more defined properties of the visual asset, such as via data structure introspection, reading properties from an object model representation of visual content, or the like, to obtain the content and contextual information based on which the defined functionality executes. Execution engine 124 invokes the functionality attached to the visual asset by passing the content of and/or contextual information associated with the visual asset to the functional code in functionality container 220. Based on the rendering hooks defined in the functional code, execution engine 124 performs the defined functionality in the functional code using the content of and/or contextual information associated with the visual asset. For example, functional code that renders text on a per-character basis can ingest the content of the visual asset and replace the rendering of the content in the visual asset with rendering code that renders each character of the content in the visual asset using a defined effect different from a default effect. In some embodiments, the functionality attached to the visual asset that is invoked at render time and replaces the default rendering code provided by execution engine 124 may modify the appearance of content within a visual asset (e.g., change the case in which characters are rendered from upper case to lower case or vice versa), apply animation effects to characters as such characters are rendered, or apply other transformations to the content within a visual asset.

Because execution engine 124 executes functional code associated with a visual asset at rendering time, execution engine 124 may have access to the contents of and contextual information associated with the visual asset. Thus, execution engine 124 can perform various actions based on the state of the visual asset on which the actions are to be performed even though execution engine 124 and the functional components associated with the document may not have access to the contents of and contextual information associated with the visual asset when the functional code is loaded into the execution environment provided by execution engine 124.

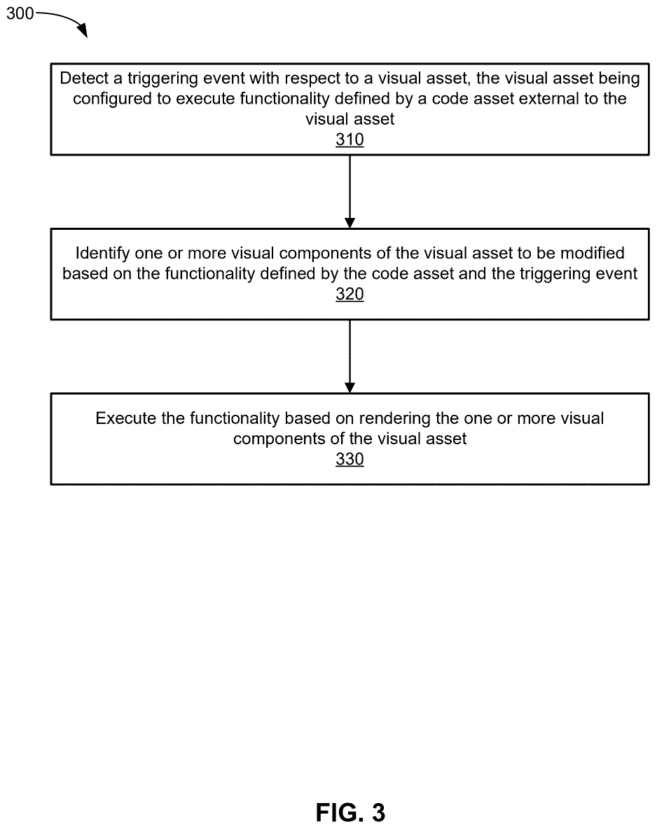

FIG. 3 is a flow diagram illustrating example operations 300 for flow diagram of method steps for executing functionality associated with a visual asset when the visual asset is rendered, according to some embodiments. The operations 300 may be performed, for example, by a computing system including one or more processors, such as the processor(s) 102 of the computing device 100 illustrated in FIG. 1, on which an execution engine 124 that renders visual assets in an execution environment executes.

As illustrated, the operations 300 begin at block 310, where the execution engine 124 detects a triggering event with respect to a visual asset. Generally, the visual asset may be configured to execute functionality defined by a code asset external to the visual asset. For example, the functionality defined by the code asset may include actions that are performed based on the content of a visual asset to which the code asset is attached or a related visual asset in a document rendered by execution engine 124. The code asset may specify, for example, a rendering event or hook that the code asset replaces, such as a per-character rendering event, a per-string rendering event, or the like.

At block 320, operations 300 proceed with execution engine 124 identifying one or more visual components of the visual asset to be modified based on the functionality defined by the code asset and the triggering event.

In some embodiments, identifying the one or more visual components of the visual asset to be modified is performed at runtime based on traversal of a rendering tree associated with components of the visual asset. As discussed, a rendering tree may include a node associated with the container in which the visual asset is contained in a document rendered using execution engine 124. Child nodes of the node associated with the container in which the visual asset is contained may represent functional code components associated with components of the visual asset, visual components included as part of a visual asset, or the like. A visual component that can be modified by functional code associated with the visual asset may be direct or indirect children nodes of the node associated with the functional code attached to the visual asset.

At block 330, operations 300 proceed with execution engine 124 executing the functionality based on rendering the one or more visual components of the visual asset.

In some embodiments, the visual asset comprises a first container encapsulated inside a second container associated with the functionality defined by the code asset. In such an embodiment, execution engine 124 may generate a rendering tree used to render a document including the visual asset and the functionality defined by the code asset. In doing so, execution engine 124 can generate a node associated with the second container as a parent node in the rendering tree to a node associated with the first container. By doing so, the functionality attached to the visual asset may be loaded into the execution environment provided by execution engine 124 before execution engine 124 renders the visual asset and invokes code at render time to perform the functionality attached to the visual asset.

In some embodiments, to execute the functionality based on rendering components of the visual asset, execution engine 124 determines that a component being rendered is associated with functionality defined by the code asset. As discussed, a determination that a component is associated with functionality defined by a code asset may be based on traversal of a rendering tree including functional code in a container that is a parent of a node associated with a visual asset. The execution engine 124 can further determine that a component being rendered is associated with functionality defined by the code asset based on the presence of a rendering hook or other override in the code asset specifying that code other than the default rendering code for the visual asset is to be executed when execution engine 124 renders the visual asset. Execution engine 124 can then render the component based on the functionality defined by the code asset, the functionality defined by the code asset replacing rendering code for the component.

In some embodiments, the visual asset comprises a code-defined visual asset. The functionality defined by the code asset may be configured to be executed when code associated with rendering the visual asset is executed. As discussed, the functionality defined by the code asset may hook into specified rendering events performed by execution engine 124. When a rendering event is performed with respect to a visual asset, execution engine 124 can determine whether the visual asset is associated with functional code that overrides the default rendering code for the visual asset. If the visual asset is associated with functional code that overrides the default rendering code for the visual asset, execution engine 124 executes the functional code attached to the visual asset instead of the default rendering code for the visual asset.

In some embodiments, the functionality is executed without predefined knowledge of a structure of the visual asset. The functionality may be performed after a rendering event has occurred. By doing so, as discussed, execution engine 124 can execute the functionality based on the content of and/or contextual information associated with the visual asset. This information may not be known prior to a time at which the visual asset is rendered in the execution environment.

In some embodiments, execution engine 124 executes the functionality attached to the visual asset based on obtaining one or more properties of the component at rendering time for the component. Execution engine 124 then modifies the component based on the obtained one or more properties and the functionality defined by the code asset. For example, execution engine 124 can change how content is rendered in a visual asset, such as by adding animation effects to textual content in a code asset or otherwise changing the appearance of a visual asset in response to an input that triggers execution of the functionality attached to the visual asset.

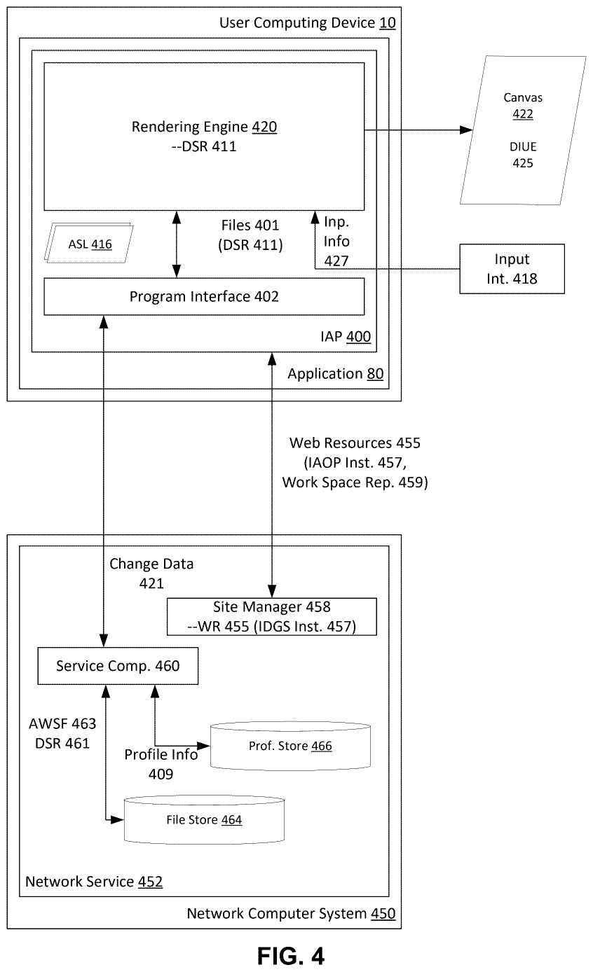

FIG. 4 illustrates a network computing system to implement an interactive application platform on a user computing device, according to some embodiments. A network computing system such as illustrated in FIG. 4 can be implemented using one or more servers which communicate with user computing devices over one or more networks. The network computer system 450 illustrated in FIG. 4 may correspond, for example, to the computing device 100 illustrated in FIG. 1 and can be used to generate and/or modify visual content based on generative artificial intelligence models and an input prompt specifying a design objective for the visual content.

In some embodiments, the network computing system 450 performs operations to enable an interactive application platform (“IAP 400”) to be implemented on user computing devices 10. In some embodiments, the IAP 400 can be implemented by the user initiating a session (e.g., user accessing a website) to receive programmatic resources of the IAP 400. A browser component executes the programmatic resources to implement the IAP 400, with functionality to receive user input and to render content that is based on or responsive to user input. As described, the IAP 400 is implemented to enable the user to create various types of content, such as interactive graphic designs, art, whiteboard content, program code renderings, presentations, and/or textual content. As further described, the IAP 400 can include logic (“ASL 416”) for implementing one or more application services, where each application service is implemented through the IAP 400 to provide a corresponding set of functionality and user experience. The IAP 400 also implements the application services to share some resources, such as the canvas, workspace file or library of design elements. Further, the IAP 400 enables multiple application services to be used during a given online session and/or with respect to a particular application service.

According to some embodiments, a user of computing device 10 operates web-based application 80 to access a network site, where programmatic resources are retrieved and executed to implement the IAP 400. The web-based application 80 can execute scripts, code and/or other logic (the “programmatic components”) to implement functionality of the IAP 400. In some embodiments, the web-based application 80 can correspond to a commercially available browser, such as GOOGLE CHROME (developed by GOOGLE, INC.) or SAFARI (developed by APPLE, INC.). In some embodiments, the processes of the IAP 400 can be implemented as scripts and/or other embedded code which web-based application 80 downloads from a network site. For example, the web-based application 80 can execute code that is embedded within a webpage to implement processes of the IAP 400. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., web-page structured in accordance with HTML 5.0 or other versions, as provided under standards published by W3C or WHATWG consortiums). In some embodiments, the rendering engine 420 may utilize graphics processing unit (GPU) accelerated logic, such as provided through WebGL (Web Graphics Library) programs which execute Graphics Library Shader Language (GLSL) programs that execute on GPUs.

The IAP 400 can be implemented as part of a network service, where web-based application 80 communicates with one or more remote computers (e.g., server used for a network service) to execute processes of the IAP 400. The web-based application 80 retrieves some or all of the programmatic resources for implementing the IAP 400 from a network site. The web-based application 80 may also access various types of data sets in providing the IAP 400. The data sets can correspond to files and design libraries (e.g., predesigned design elements), which can be stored remotely (e.g., on a server, in association with an account) or locally. In some embodiments, the network computer system 450 provides a shared design library which the user computing device 10 can use with any of the application services provided through the IAP 400. In this way, the user may initiate a session to implement the IAP 400 for the purpose of creating or editing the workspace file, as rendered on the canvas 422, in accordance with one of multiple collaborative application services of the IAP 400.

In some embodiments, the IAP 400 includes a program interface 402, an input interface 418 and a rendering engine 420. The program interface 402 can include one or more processes which execute to access and retrieve programmatic resources from local and/or remote sources. In an implementation, the program interface 402 can generate, for example, a canvas 422, using programmatic resources which are associated with web-based application 80 (e.g., HTML 5.0 canvas). As an addition or variation, the program interface 402 can trigger or otherwise cause the canvas 422 to be generated using programmatic resources and data sets (e.g., canvas parameters) which are retrieved from local (e.g., memory) or remote sources (e.g., from network service).

The program interface 402 may also retrieve programmatic resources that include an application framework for use with canvas 422. The application framework can include data sets which define or configure, for example, a set of interactive graphic tools that integrate with the canvas 422 and which comprise the input interface 418, to enable the user to provide input to generate or update content rendered on the canvas 422.

According to some embodiments, the input interface 418 can be implemented as a functional layer that is integrated with the canvas 422 to detect and interpret user input. The input interface 418 can, for example, process a user's interaction with an input mechanism (e.g., pointer device, keyboard) of the user computing device, to detect, for example, cursor positioning/movement with respect to the canvas 422, hover input (e.g., pre-selection input), selection input (e.g., clicks or double clicks), shortcuts (e.g., key board inputs) and other inputs. In processing a user's interaction with a pointer device, the input interface 418 can use a reference of the canvas 422 to identify a screen location of a user's cursor as the user moves or otherwise interacts with the pointer device. Additionally, the input interface 418 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In some embodiments, the input interface 418 can interpret, for example, a series of inputs as a design tool selection (e.g., shape selection based on location of input), as well as inputs to define attributes (e.g., dimensions) of a selected shape. In some embodiments, the input interface 418 can interpret a continuous input (corresponding to a continuous movement of the user's pointer device) as selecting a tool (e.g., shape too) and canvas location where an output of the selected tool is to appear.

In some embodiments, the IAP 400 includes application service logic 416 to enable multiple application services to be utilized during a given user session, where each application service provides the user with a particular functionality and/or user experience. As described by some embodiments, each application service is implemented by the IAP 400 utilizing a corresponding application service logic 416 to configure the interface component 418, rendering engine 420 and/or other components of the IAP 400 to provide the functionality and user experience of the corresponding application service. In this way, the IAP 400 enables the user to operate multiple application services during one online session. Further, the different application services can share resources, including programmatic resources of the IAP 400, such as canvas 422. In this way, each application service can contribute content to and/or utilize features and content provided with the canvas 422 during a given session. Still further, the application services can be implemented as alternative modalities of IAP 400, such that the user can toggle between modes, where each mode provides a particular functionality and user experience. In some embodiments, each application service can utilize a common workspace file associated with the user. By default, a computing device that opens the workspace file can utilize a default application service to access and/or update that workspace file. The user may also switch the mode of operation of the IAP 400 to utilize a different application service to access, use and/or update the workspace file.

The network computing system 450 can include a site manager 458 to manage a website where a set of web-resources 455 (e.g., web page) are made available for the web-based application 80 of user computing devices 10. The web-resources 455 can include instructions, such as scripts or other logic (“ICAP instructions 457”), which are executable by browsers or web components of user computing devices. The web resources 455 can also include (i) resources that are to be shared as between application services, provided to the user computing devices in connection with the user computing devices utilizing either of the application services, and (ii) application specific resources, which execute on the user computing devices for a particular one of the available application services. The web resources 455 can also include a design library of design elements that is partially or fully shared as between the application services. The library of design elements can enable the user to select predetermined design elements for use on the canvas 422 in connection with the user utilizing either of the application services.

In some variations, once the computing device 10 accesses and downloads the web-resources 455, web-based application 80 executes the IAP instructions 457 to implement functionality as described above. For example, the IAP instructions 457 can be executed by web-based application 80 to initiate the program interface 402 on the user computing device 10. The initiation of the program interface 402 may coincide with the establishment of, for example, a web-socket connection between the program interface 402 and a service component 460 of the network computing system 450.

In some embodiments, the web-resources 455 includes logic which web-based application 80 executes to initiate one or more processes of a program interface 402, causing the IAP 400 to retrieve additional programmatic resources and data sets for implementing functionality as described by examples. The web resources 455 can, for example, embed logic (e.g., JAVASCRIPT code), including GPU accelerated logic, in an HTML page for download by computing devices of users. The program interface 402 can be triggered to retrieve additional programmatic resources and data sets from, for example, the network service 452, and/or from local resources of the computing device 10, in order to implement each of the multiple application services of the IAP 400. For example, some of the components of the IAP 400 can be implemented through webpages that can be downloaded onto the computing device 10 after authentication is performed, and/or once the user performs additional actions (e.g., download one or more pages of the workspace associated with the account identifier). Accordingly, in examples as described, the network computing system 450 can communicate the IAP instructions 457 to the computing device 10 through a combination of network communications, including through downloading activity of web-based application 80, where the IAP instructions 457 are received and executed by web-based application 80.

The computing device 10 can use web-based application 80 to access a website of the network service 452 to download the webpage or web resource. Upon accessing the website, web-based application 80 can automatically (e.g., through saved credentials) or through manual input, communicate an account identifier to the service component 460. In some embodiments, web-based application 80 can also communicate one or more additional identifiers that correlate to a user identifier.

Additionally, in some embodiments, the service component 460 can use the user or account identifier of the user identifier to retrieve profile information 409 from a user profile store 466. As an addition or variation, profile information 409 for the user can be determined and stored locally on the user's computing device 10.

The service component 460 can also retrieve the files of an active workspace (“active workspace files 463”) that are linked to the user account or identifier from a file store 464. The profile store 466 can also identify the workspace that is identified with the account and/or user, and the file store 464 can store the data sets that comprise the workspace. The data sets stored with the file store 464 can include, for example, the pages of a workspace and one or more data structure representations 461 for the design under edit which is renderable from the respective active workspace files.

As an addition or variation, each file can be associated with metadata that identifies the application service that was used to create the particular file. In some embodiments, the metadata identifies the default application service for viewing, utilizing or otherwise updating the application service.

Additionally, in some embodiments, the service component 460 provides a representation 459 of the workspace associated with the user to the web-based application 80, where the representation identifies, for example, individual files associated with the user and/or user account. The workspace representation 459 can also identify a set of files, where each file includes one or multiple pages, and each page including objects that are part of a design interface.

On the user device 10, the user can view the workspace representation through web-based application 80, and the user can elect to open a file of the workspace through web-based application 80. In some embodiments, upon the user electing to open one of the active workspace files 463, web-based application 80 initiates the canvas 422. For example, the IAP 40 can initiate an HTML 5.0 canvas as a component of web-based application 80, and the rendering engine 120 can access one or more data structures representations 411 of content rendered on the canvas 422.

The IAP 400 utilizes application service logic 416 to implement multiple modes of operation, where each mode corresponds to an application service. As described, the application service logic 416 associated with each service application can include instructions and data for configuring the components of IAP 400 to include functionality and features of the corresponding application service. Accordingly, the application service logic 416 can, for example, configure the application framework and/or input interface 418 to differ in form, functionality and/or configuration as between the alternative modes of the IAP 400. Additionally, the type of actions and interactions which the user can perform to register input can vary based on the modes of operation. Still further, the different modes of operation can include different input or user-interface features for the user to select and use for inclusion on the canvas 422. By way of example, when the IAP 400 is operating in a mode for whiteboarding service application, the program interface 402 can provide input features to enable a user to select a design element that is in the form of a “sticky note,” while in an alternative mode for an interactive graphic design service application, the “sticky note feature” is not available. However, in the alternative mode, the user may be able to select anyone of numerous possible shapes or previously designed objects which the user can write textual messages in for display on the canvas 422.

Additionally, the application service logic 416 can configure the operation of the rendering engine 420, such that the functionality and behavior of the rendering engine 420 differs as between different application services. In this way, the rendering engine 420 functions to provide alternative behaviors for different modes of operation, coinciding with the particular service application that is active. By way of example, the configuration of the rendering engine 420 can affect the appearance of the canvas 422, the appearance (e.g., visual attributes) of rendered content elements on the canvas 422, the behavior or representation of user interaction (e.g., whether the user cursor or pointe device is represented on the canvas 422), the type or specific content that is rendered, the physic engine that is used by the rendering engine to represent dynamic events (e.g., the object being moved), what user operations can be performed (e.g., whether select objects can be resized), and the like.

Additionally, each of the application services can utilize a shared library of content elements (e.g., graphic design element), as well as core functionality that enables design elements to be shared and updated between the different application services that are available through the platform. Additionally, the workspace file created and edited through use of one application service can be utilized with the other application service. Moreover, the transition between application services can be seamless—for example, the user computing device 10 can open a workspace file using the first application service (e.g., interactive graphic design application service for UIX design) then seamlessly switch to using the second application service (e.g., whiteboarding application service) with the same file, without closing the workspace file. In some embodiments, each application service enables the user to update the workspace file even while the workspace file is in use by other computing devices (e.g., such as in a collaborative environment). In some embodiments, the user can mode switch the IAP 400 to switch which application service is in use, with each application service utilizing the workspace file.

### EXAMPLE CLAUSES

Various aspects of the present disclosure are described in the following numbered clauses.
1. In some embodiments, a processor-implemented method, comprising: detecting a triggering event with respect to a visual asset, the visual asset being configured to execute functionality defined by a code asset external to the visual asset; identifying one or more visual components of the visual asset to be modified based on the functionality defined by the code asset and the triggering event; and executing the functionality based on rendering the one or more visual components of the visual asset.
2. The method of clause 1, wherein the visual asset comprises a first container encapsulated inside a second container associated with the functionality defined by the code asset.
3. The method of any of clauses 1 or 2, wherein executing the functionality based on rendering components of the visual asset comprises: determining that a component being rendered is associated with functionality defined by the code asset; and rendering the component based on the functionality defined by the code asset, the functionality defined by the code asset replacing rendering code for the component.
4. The method of any of clauses 1 through 3, wherein identifying the one or more visual components of the visual asset to be modified is performed at runtime based on traversal of a rendering tree associated with components of the visual asset.
5. The method of clause 4, wherein the functionality comprises a parent node to nodes associated with components implementing the functionality in the rendering tree.
6. The method of any of clauses 1 through 5, wherein the visual asset comprises a code-defined visual asset and the functionality defined by the code asset is configured to be executed when code associated with rendering the visual asset is executed.
7. The method of any of clauses 1 through 6, wherein the functionality is executed without predefined knowledge of a structure of the visual asset.
8. The method of any of clauses 1 through 7, wherein executing the functionality comprises: obtaining one or more properties of the one or more visual components at rendering time for the one or more visual components; and modifying the one or more visual components based on the obtained one or more properties and the functionality defined by the code asset.
9. A processing system, comprising: at least one memory having executable instructions thereon; and one or more processors configured to execute the executable instructions to cause the processing system to perform the method of any of clauses 1 through 8.
10. A processing system, comprising: means for performing the method of any of clauses 1 through 8.
11. A non-transitory computer-readable medium having executable instructions stored thereon which, when processed by one or more processors, causes the one or more processors to perform the method of any of clauses 1 through 8.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor-implemented method, comprising:
detecting a triggering event with respect to a visual asset, the visual asset being configured to execute functionality defined by a code asset external to the visual asset;
identifying one or more visual components of the visual asset to be modified based on the functionality defined by the code asset and the triggering event; and
executing the functionality based on rendering the one or more visual components of the visual asset.

2. The method of claim 1, wherein the visual asset comprises a first container encapsulated inside a second container associated with the functionality defined by the code asset.

3. The method of claim 1, wherein executing the functionality based on rendering components of the visual asset comprises:
determining that a component being rendered is associated with functionality defined by the code asset; and
rendering the component based on the functionality defined by the code asset, the functionality defined by the code asset replacing rendering code for the component.

4. The method of claim 1, wherein identifying the one or more visual components of the visual asset to be modified is performed at runtime based on traversal of a rendering tree associated with components of the visual asset.

5. The method of claim 4, wherein the functionality comprises a parent node to nodes associated with components implementing the functionality in the rendering tree.

6. The method of claim 1, wherein the visual asset comprises a code-defined visual asset and the functionality defined by the code asset is configured to be executed when code associated with rendering the visual asset is executed.

7. The method of claim 1, wherein the functionality is executed without predefined knowledge of a structure of the visual asset.

8. The method of claim 1, wherein executing the functionality comprises:
obtaining one or more properties of the one or more visual components at rendering time for the one or more visual components; and
modifying the one or more visual components based on the obtained one or more properties and the functionality defined by the code asset.

9. A processing system, comprising:
at least one memory having executable instructions stored thereon; and
one or more processors configured to execute the executable instructions to cause the processing system to:
detect a triggering event with respect to a visual asset, the visual asset being configured to execute functionality defined by a code asset external to the visual asset;
identify one or more visual components of the visual asset to be modified based on the functionality defined by the code asset and the triggering event; and
execute the functionality based on rendering the one or more visual components of the visual asset.

10. The processing system of claim 9, wherein the visual asset comprises a first container encapsulated inside a second container associated with the functionality defined by the code asset.

11. The processing system of claim 9, wherein to execute the functionality based on rendering components of the visual asset, the one or more processors are configured to cause the processing system to:
determine that a component being rendered is associated with functionality defined by the code asset; and
render the component based on the functionality defined by the code asset, the functionality defined by the code asset replacing rendering code for the component.

12. The processing system of claim 9, wherein the one or more processors are configured to cause the processing system to identify the one or more visual components of the visual asset to be modified at runtime based on traversal of a rendering tree associated with components of the visual asset.

13. The processing system of claim 12, wherein the functionality comprises a parent node to nodes associated with components implementing the functionality in the rendering tree.

14. The processing system of claim 9, wherein the visual asset comprises a code-defined visual asset and the functionality defined by the code asset is configured to be executed when code associated with rendering the visual asset is executed.

15. The processing system of claim 9, wherein the functionality is executed without predefined knowledge of a structure of the visual asset.

16. The processing system of claim 9, wherein to execute the functionality, the one or more processors are configured to cause the processing system to:
obtain one or more properties of the one or more visual components at rendering time for the one or more visual components; and
modify the one or more visual components based on the obtained one or more properties and the functionality defined by the code asset.

17. A non-transitory computer-readable medium having executable instructions stored thereon which, when executed by a processor, performs an operation comprising:
detecting a triggering event with respect to a visual asset, the visual asset being configured to execute functionality defined by a code asset external to the visual asset;
identifying one or more visual components of the visual asset to be modified based on the functionality defined by the code asset and the triggering event; and
executing the functionality based on rendering the one or more visual components of the visual asset.

18. The non-transitory computer-readable medium of claim 17, wherein executing the functionality based on rendering components of the visual asset comprises:
determining that a component being rendered is associated with functionality defined by the code asset; and
rendering the component based on the functionality defined by the code asset, the functionality defined by the code asset replacing rendering code for the component.

19. The non-transitory computer-readable medium of claim 17, wherein identifying the one or more visual components of the visual asset to be modified is performed at runtime based on traversal of a rendering tree associated with components of the visual asset.

20. The non-transitory computer-readable medium of claim 17, wherein executing the functionality comprises:
obtaining one or more properties of the one or more visual components at rendering time for the one or more visual components; and
modifying the one or more visual components based on the obtained one or more properties and the functionality defined by the code asset.
